(19) United States
(12) Patent Application Publication
(10) Pub. No.: US 2025/0041785 A1
(43) Pub. Date: Feb. 6, 2025

(54) CANISTER

(71) Applicant: FUTABA INDUSTRIAL CO., LTD., Okazaki-shi (JP)

(72) Inventor: Koji Iwamoto, Okazaki-shi (JP)

(21) Appl. No.: 18/776,586

(22) Filed: Jul. 18, 2024

(30) Foreign Application Priority Data
Jul. 31, 2023 (JP) 2023-124730
Jul. 31, 2023 (JP) 2023-124731
Jul. 31, 2023 (JP) 2023-124732

(51) Int. Cl. B01D 53/04; B01J 20/18; B01J 20/20; B01J 20/28; F02M 25/08

(52) U.S. Cl. CPC B01D 53/0415; B01J 20/18; B01J 20/20; B01J 20/28023; B01J 20/28028; B01J 20/28035; B01J 20/2804; F02M 25/0854; B01D 2253/102; B01D 2253/108; B01D 2253/25; B01D 2253/34; B01D 2257/702; B01D 2259/40086; B01D 2259/4516

(57) ABSTRACT

One aspect of the present disclosure provides a canister configured to adsorb and desorb fuel vapor generated in a fuel tank of a vehicle. The canister includes a charge port configured to take in the fuel vapor, a purge port configured to release the fuel vapor, an atmosphere port open to an atmosphere, a first adsorption chamber and a second adsorption chamber directly coupled to the charge port and the purge port or indirectly coupled to the charge port and the purge port via an additional chamber, a first adsorption member housed in the first adsorption chamber, and a second adsorption member housed in the second adsorption chamber. The first adsorption member includes two or more adsorption layers having properties to adsorb the fuel vapor and an adjustment layer having an air-permeability and interposed between the two or more adsorption layers.

### CROSS-REFERENCE TO RELATED APPLICATIONS

The present application claims the benefit of Japanese Patent Application No. 2023-124730, No. 2023-124731, and No. 2023-124732 each filed on Jul. 31, 2023 with the Japan Patent Office, the entire disclosures of which are hereby incorporated by reference herein.

### BACKGROUND

The present disclosure relates to a canister.

A canister that inhibits vapor fuel from being released into the atmosphere is coupled to a fuel tank of a vehicle. The canister adsorbs the vapor fuel to an adsorption member, desorbs fuel from the adsorption member with sucked air for purging, and supplies the purged fuel to an engine of the vehicle.

Known as such an adsorption member of a canister, there is an adsorption member formed by stacking two or more adsorption sheets in layers as disclosed in Japanese Patent No. 7250145.

### SUMMARY

In cases where a canister is provided with an adsorption member formed by stacking two or more adsorption sheets as described above, the adsorption sheets are closely stacked, and thus an airflow resistance may be high between the adsorption sheets.

One aspect of the present disclosure preferably provides a canister that can reduce an airflow resistance of an adsorption member having a layered structure.

An aspect of the present disclosure provides a canister configured to adsorb and desorb fuel vapor generated in a fuel tank of a vehicle. The canister includes: a charge port configured to take in the fuel vapor; a purge port configured to release the fuel vapor; an atmosphere port open to an atmosphere; a first adsorption chamber and a second adsorption chamber directly coupled to the charge port and the purge port, or indirectly coupled to the charge port and the purge port via an additional chamber; a first adsorption member housed in the first adsorption chamber; and a second adsorption member housed in the second adsorption chamber. The first adsorption member includes two or more adsorption layers having properties to adsorb the fuel vapor and an adjustment layer having an air-permeability and interposed between the two or more adsorption layers. Specifically, in the canister, one adsorption chamber of the first adsorption chamber and the second adsorption chamber is directly coupled to the charge port and the purge port, and the other adsorption chamber of the first adsorption chamber and the second adsorption chamber is indirectly coupled to the charge port and the purge port via an additional chamber.

The configuration in which the adjustment layer is arranged between the adsorption layers enables reduction in airflow resistance between the adsorption layers. Thus, it is possible to reduce the airflow resistance of the first adsorption member having a layered structure by means of a relatively simple and easy configuration.

In the canister described above, the adjustment layer may have an airflow resistance smaller than individual airflow resistances of the two or more adsorption layers. This configuration facilitates an effect of reducing the airflow resistance between the adsorption layers.

In the canister described above, the first adsorption member may include an area in which the adjustment layer is not arranged between the two or more adsorption layers. This configuration facilitates adjustment to the airflow resistance of the first adsorption member.

In the canister described above, the two or more adsorption layers and the adjustment layer may be a portion of a wound body of the adsorption sheet and the adjustment sheet placed on the adsorption sheet. This configuration facilitates formation of the first adsorption member including the two or more adsorption layers and the adjustment layer.

In the canister described above, the first adsorption member may further include a core material, and the adsorption sheet and the adjustment sheet may be wound around the core material. This configuration makes it possible with the core material to bring adjacent layers of the first adsorption member into closer contact with each other. This reduces the gaps of the first adsorption member, and thus makes it possible to inhibit passage of the fuel vapor while reducing the airflow resistance of the first adsorption member.

In the canister described above, the first adsorption chamber may be directly coupled to the atmosphere port. This configuration enables reduction in leakage of the fuel vapor from the atmosphere port.

### BRIEF DESCRIPTION OF THE DRAWINGS

Example embodiments of the present disclosure will be described hereinafter with reference to the accompanying drawings, in which:

FIG. 1 is a schematic view of a canister according to an embodiment;

FIG. 2A is a schematic perspective view of a first adsorption member in the canister in FIG. 1;

FIG. 2B is a schematic plane view of the first adsorption member in FIG. 2A;

FIG. 3A is a schematic plane view of a first adsorption member according to an embodiment which is different from the embodiment in FIGS. 2A and 2B;

FIG. 3B is a schematic perspective view of the first adsorption member in FIG. 3A;

FIG. 4 is a schematic developed view of an adsorption sheet and an adjustment sheet in the first adsorption member in FIGS. 2A and 2B;

FIG. 5A is a schematic developed view of an adsorption sheet and an adjustment sheet according to an embodiment which is different from the embodiment in FIG. 4;

FIG. 5B is a schematic perspective view of a first adsorption member including the adsorption sheet and the adjustment sheet in FIG. 5A;

FIG. 6A is a schematic developed view of an adsorption sheet and an adjustment sheet according to an embodiment which is different from the embodiment in FIG. 4;

FIG. 6B is a schematic perspective view of a first adsorption member including the adsorption sheet and the adjustment sheet in FIG. 6A;

FIG. 7 is a schematic perspective view of a first adsorption member according to an embodiment which is different from the embodiment in FIGS. 2A and 2B;

FIG. 8A is a schematic perspective view of a first adsorption member according to an embodiment which is different from the embodiment in FIGS. 2A and 2B; and

FIG. 8B is a schematic perspective view of a first adsorption member according to an embodiment which is different from the embodiment in FIGS. 2A and 2B.

### DETAILED DESCRIPTION OF EXEMPLARY EMBODIMENTS

### 1. First Embodiment

### [1-1. Configuration]

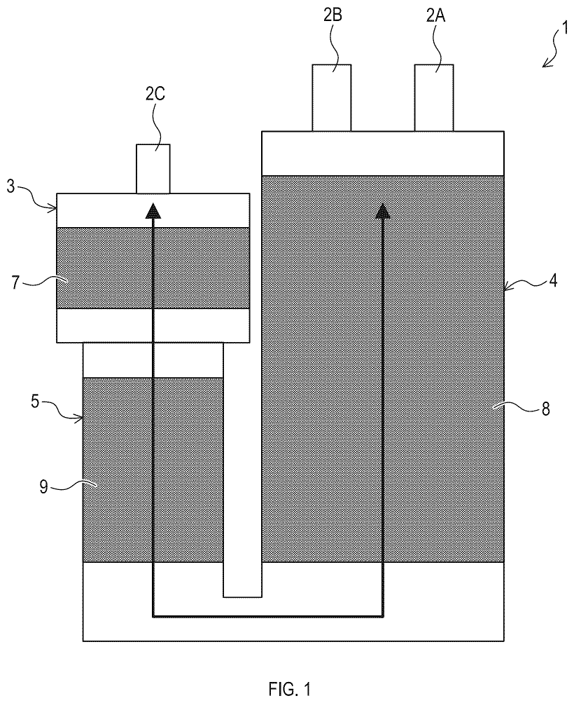

FIG. 1 shows a canister 1 which is a fuel vapor treatment device that adsorbs and desorbs fuel vapor generated in a fuel tank of a vehicle.

The canister 1 includes a charge port 2A, a purge port 2B, an atmosphere port 2C, a first adsorption chamber 3, a second adsorption chamber 4, a third adsorption chamber 5, a first adsorption member 7, a second adsorption member 8, and a third adsorption member 9.

### <Charge Port>

The charge port 2A is coupled to the fuel tank of the vehicle via a pipe. The charge port 2A is configured to take in the fuel vapor generated in the fuel tank to the inside of the canister 1.

### <Purge Port>

The purge port 2B is coupled to an air intake pipe of an engine of the vehicle via a purge valve. The purge port 2B is configured to release, from the canister 1, the fuel vapor in the canister 1 and supply the released fuel vapor to the engine.

### <Atmosphere Port>

The atmosphere port 2C is open to the atmosphere. The atmosphere port 2C releases, to the atmosphere, gas from which the fuel vapor has been removed. The atmosphere port 2C takes in external air (that is, purge air) to desorb (that is, purge) the fuel vapor adsorbed by the canister 1.

### <First Adsorption Chamber>

The first adsorption chamber 3 houses the first adsorption member 7. The first adsorption chamber 3 is directly coupled to the atmosphere port 2C without any other adsorption chamber therebetween. The first adsorption chamber 3 communicates with the atmosphere port 2C and the third adsorption chamber 5. The first adsorption chamber 3 releases, from the atmosphere port 2C, gas from which the fuel vapor has been adsorbed.

### <Second Adsorption Chamber>

The second adsorption chamber 4 houses the second adsorption member 8. The second adsorption chamber 4 is directly coupled to the charge port 2A and the purge port 2B without any other adsorption chamber therebetween. The second adsorption chamber 4 communicates with the charge port 2A, the purge port 2B, and the third adsorption chamber 5. The second adsorption chamber 4 adsorbs the fuel vapor which is taken in from the charge port 2A. The second adsorption chamber 4 releases the adsorbed fuel vapor from the purge port 2B.

### <Third Adsorption Chamber>

The third adsorption chamber 5 houses the third adsorption member 9. The third adsorption chamber 5 is arranged in a flow path of the fuel vapor between the first adsorption chamber 3 and the second adsorption chamber 4.

The fuel vapor taken in from the charge port 2A is adsorbed to the second adsorption member 8 in the second adsorption chamber 4. A portion of the fuel vapor remained un-adsorbed in the second adsorption chamber 4 flows into the third adsorption chamber 5 and is adsorbed to the third adsorption member 9 in the third adsorption chamber 5.

Further, a portion of the fuel vapor remained un-adsorbed in the third adsorption chamber 5 flows into the first adsorption chamber 3 and is adsorbed to the first adsorption member 7 in the first adsorption chamber 3. Gas from which the fuel vapor has been adsorbed is released from the atmosphere port 2C.

The fuel vapor which has been adsorbed to the first to the third adsorption members 7 to 9 respectively in the first to third adsorption chambers 3 to 5 is released to the engine from the purge port 2B as air is drawn in from the atmosphere port 2C. Accordingly, air containing the fuel vapor is supplied to the engine.

### <First Adsorption Member>

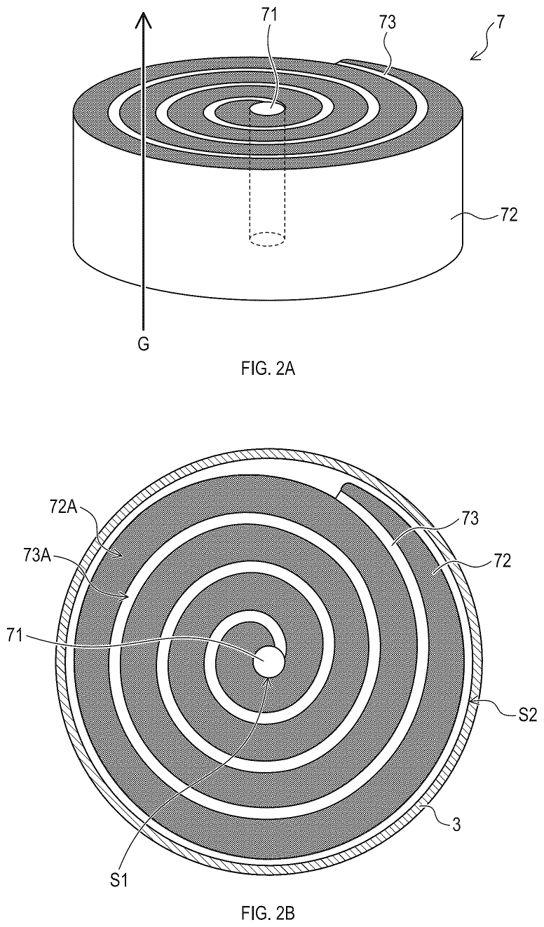

The first adsorption member 7 is housed in the first adsorption chamber 3. As shown in FIGS. 2A and 2B, the first adsorption member 7 includes a core material 71, an adsorption sheet 72, and an adjustment sheet 73.

### <Core Material>

The core material 71 is a non-air-permeable member in a rod shape. The core material 71 is made of a material with substantially no air-permeability and has a structure that does not substantially allow passage of gas (in other words, does not have a communication hole or communication space).

The first adsorption member 7 is arranged such that an axial direction of the core material 71 is parallel to a flow direction G of the fuel vapor in the first adsorption chamber 3. In other words, in the first adsorption chamber 3, the fuel vapor flows in the axial direction of the core material 71.

As shown in FIG. 2B, the outer-circumferential surface of the core material 71 has a cross-section, which is perpendicular to the axial direction of the core material 71, in a shape (hereinafter, “first shape”) S1 similar to a shape (hereinafter, “second shape”) S2 of a cross-section of the inner-circumferential surface of the first adsorption chamber 3 perpendicular to the axial direction of the core material 71. In a case, for example, where the second shape S2 of the first adsorption chamber 3 is circular (in other words, in a case where the first adsorption chamber 3 has an internal space of a cylindrical shape), the first shape S1 of the core material 71 is also circular (in other words, the core material 71 also has a cylindrical shape).

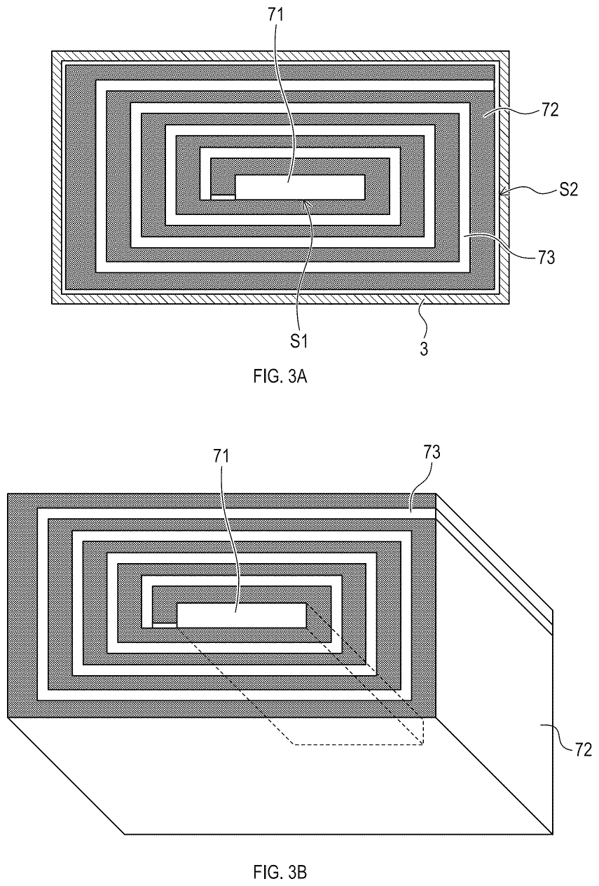

For another example, in a case where, as shown in FIG. 3A, the second shape S2 of the first adsorption chamber 3 is quadrangular (in other words, in a case where the first adsorption chamber 3 has an internal space of a quadrangular prism shape), the first shape S1 of the core material 71 is also quadrangular (in other words, the core material 71 has a quadrangular prism shape as shown in FIG. 3B).

### <Adsorption Sheet>

As shown in FIGS. 2A and 2B, the adsorption sheet 72 is wound around the core material 71 together with the adjustment sheet 73. The adsorption sheet 72 has fuel vapor adsorption properties. In other words, the adsorption sheet 72 adsorbs the fuel vapor, supplied to the canister 1 together with air and the like, and butane. The adsorption sheet 72 desorbs the fuel vapor and butane by introduction of external air.

Specifically, the adsorption sheet 72 is formed of a fiber with fuel vapor adsorption properties. For the adsorption sheet 72, a carbon-fiber woven, knitted, or unwoven fabric, for example, can be preferably used.

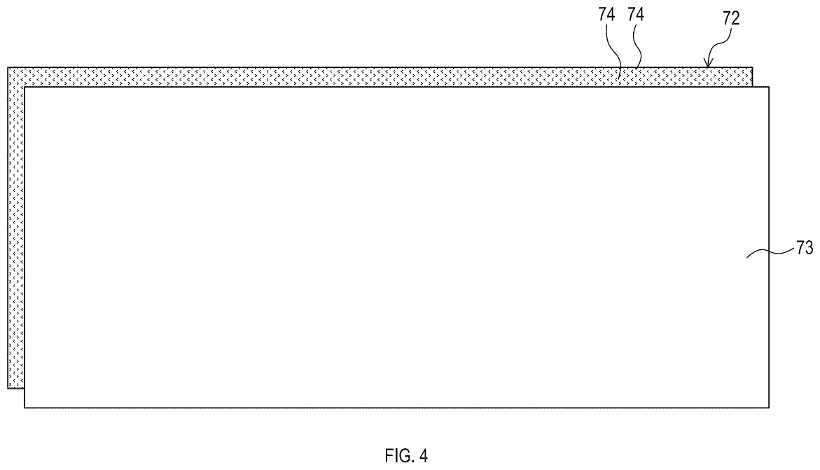

As shown in FIG. 4, the adsorption sheet 72 includes granules 74 arranged to be dispersed on the surface or the inside thereof. The granules 74 have fuel vapor adsorption properties. In other words, the first adsorption member 7 includes the granules 74 having the fuel vapor adsorption properties and arranged to be dispersed on the surface of or the inside of the adsorption sheet 72.

Examples of the granules 74 include activated carbon and zeolite. The granules 74 are positioned inside gaps between fibers (in other words, entangled with fibers) constituting the adsorption sheet 72 and thus held in the adsorption sheet 72. The adsorption sheet 72 is wound around the core material 71 with the granules 74 arranged thereon or therein. The granules 74 are arranged on or in the adsorption sheet 72 by, for example, spraying, coating, or other methods.

The adsorption sheet 72 and the granules 74 have adsorption performances that are different from each other. The adsorption sheet 72 may include two or more types (that is, different from each other in terms of adsorption capacity and/or desorption capacity) of the granules 74 arranged therein/thereon. The adsorption sheet 72 may include a first area in which the granules 74 are arranged and a second area in which the granules 74 are not arranged.

### <Adjustment Sheet>

As shown in FIGS. 2A and 2B, the adjustment sheet 73 is wound around the core material 71. The adjustment sheet 73 is air-permeable.

The adjustment sheet 73 has an airflow resistance and a density respectively smaller than the airflow resistance and the density of the adsorption sheet 72. The adjustment sheet 73 may have or need not have fuel vapor adsorption properties. Examples of the material of the adjustment sheet 73 include urethane foams.

As shown in FIG. 4, the adjustment sheet 73 is placed on one surface of the adsorption sheet 72 and wound around the core material 71. As shown in FIG. 2B, the adsorption sheet 72 and the adjustment sheet 73 are wound around the core material 71 in a manner so as to form two or more cylindrical adsorption layers 72A and two or more cylindrical adjustment layers 73A.

In other words, the first adsorption member 7 includes the adsorption layers 72A with fuel vapor adsorptive properties and the adjustment layers 73A with an air-permeability, and each adjustment layer 73A is interposed between the adsorption layers 72A in the radial direction of the core material 71. The adsorption layers 72A and the adjustment layers 73A are a portion of a wound body of the adsorption sheet 72 and the adjustment sheet 73 placed on the adsorption sheet 72. The adjustment layer 73A has an airflow resistance and a density smaller than the airflow resistance and the density of the adsorption layer 72A.

The outer-circumferential surface of the adjustment layer 73A is in contact with the inner-circumferential surface of the adsorption layer 72A, and the inner-circumferential surface of the adjustment layer 73A is in contact with the outer-circumferential surface of the adsorption layer 72A. In other words, the adjustment layer 73A is interposed in its thickness direction between two adsorption layers 72A. The outermost layer of the first adsorption member 7 is the adsorption layer 72A. In other words, the adsorption sheet 72 and the adjustment sheet 73 are wound around such that the adsorption sheet 72 is positioned outside of the adjustment sheet 73.

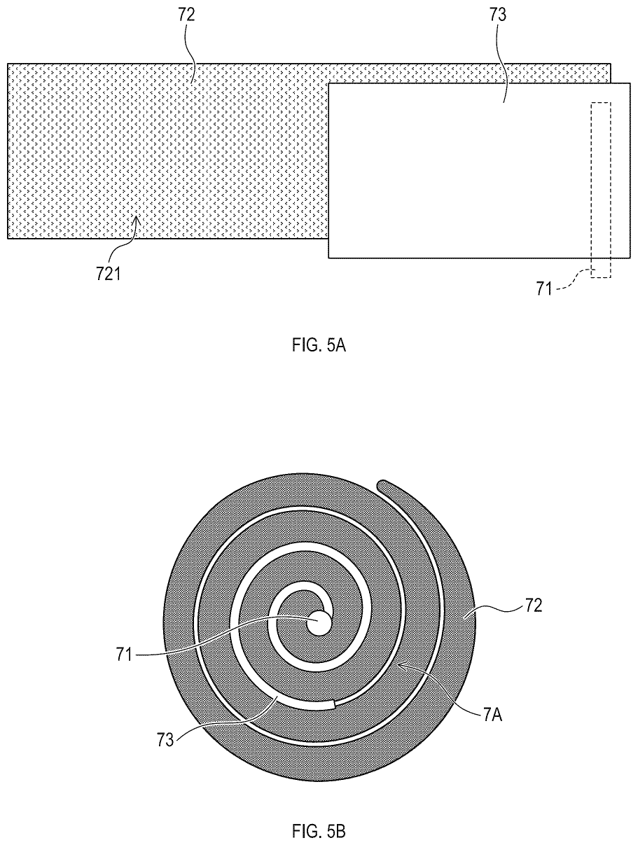

As shown in FIG. 5A, the adsorption sheet 72 may include a non-overlapping area 721 on which the adjustment sheet 73 is not placed. The non-overlapping area 721 is provided in one area of the adsorption sheet 72 opposite to an area on which the core material 71 is placed to start winding of the adsorption sheet 72 (in other words, the non-overlapping area 721 is provided in an area close to the winding-finishing end).

Winding of the adsorption sheet 72 and the adjustment sheet 73 in FIG. 5A provides the first adsorption member 7 with an unadjusted area 7A, as shown in FIG. 5B, in which the adjustment layer 73A is not arranged between the adsorption layers 72A. This configuration facilitates adjustment to the airflow resistance of the first adsorption member 7.

In the example of FIG. 5B, the unadjusted area 7A is provided near the outer-circumferential surface of the first adsorption member 7 (that is, an area away from the core material 71). In the unadjusted area 7A, two adjacent adsorption layers 72A are directly stacked one top of another. In other words, the inner-circumferential surface of the outer adsorption layer 72A is in contact with the outer-circumferential surface of the inner adsorption layer 72A.

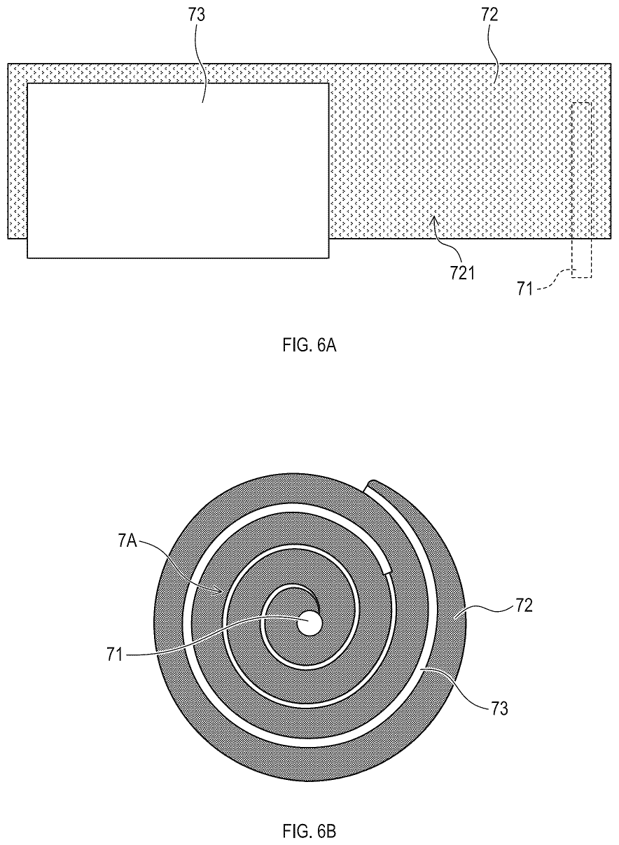

As shown in FIG. 6A, the non-overlapping area 721 may be provided in the area of the adsorption sheet 72 on which the core material 71 is placed to start winding of the adsorption sheet 72 (in other words, the non-overlapping area 721 may be provided in an area near a winding-starting end).

Winding of the adsorption sheet 72 and the adjustment sheet 73 in FIG. 6A provides the first adsorption member 7 with the unadjusted area 7A, as shown in FIG. 6B, located near the center of the wound body (that is, an area near the core material 71).

### <Second Adsorption Member and Third Adsorption Member>

The second adsorption member 8 and the third adsorption member 9 individually adsorb the fuel vapor, supplied to the canister 1 together with air and the like, and butane. The second adsorption member 8 and the third adsorption member 9 desorb the fuel vapor and butane by introduction of external air.

Examples of materials that can be used for the second adsorption member 8 and the third adsorption member 9 include activated carbon and zeolite. Examples of the activated carbon include aggregates of granular adsorbents, activated carbons formed in honeycomb shapes and the like, and fibrous activated carbons formed in sheet shapes, cubic shapes, cylindrical shapes, or polygonal-columnar shapes. The second adsorption member 8 and the third adsorption member 9 may be adsorbents of the same type or of different types. The second adsorption member 8 and the third adsorption member 9 may each include, as with the first adsorption member 7, a core material and an adsorption sheet wound around the core material.

### [1-2. Effect]

According to the embodiment described in detail hereinabove, the following effects can be achieved.
(1a) The configuration in which the adjustment layer 73A is arranged between the adsorption layers 72A enables reduction in the airflow resistance between the adsorption layers 72A. Thus, it is possible to reduce the airflow resistance of the first adsorption member 7 having a layered structure by means of a relatively simple and easy configuration.
(1b) The configuration in which the airflow resistance of the adjustment layer 73A is smaller than the airflow resistance of the adsorption layer 72A facilitates an effect of reducing the airflow resistance between the adsorption layers 72A.
(1c) The configuration in which the adsorption layers 72A and the adjustment layers 73A are a portion of the wound body of the adsorption sheet 72 and the adjustment sheet 73 facilitates formation of the first adsorption member 7 including the adsorption layers 72A and the adjustment layers 73A.
(1d) The configuration in which the adsorption sheet 72 is wound around the core material 71 makes it possible with the core material 71 to bring adjacent layers of the first adsorption member 7 into closer contact with each other. This reduces the gaps of the first adsorption member 7 and thus makes it possible to inhibit passage of the fuel vapor while reducing the airflow resistance of the first adsorption member 7.
(1e) The configuration in which the first adsorption member 7 is housed in the first adsorption chamber 3 coupled to the atmosphere port 2C enables reduction in leakage of the fuel vapor from the atmosphere port 2C.

### 2. Other Embodiments

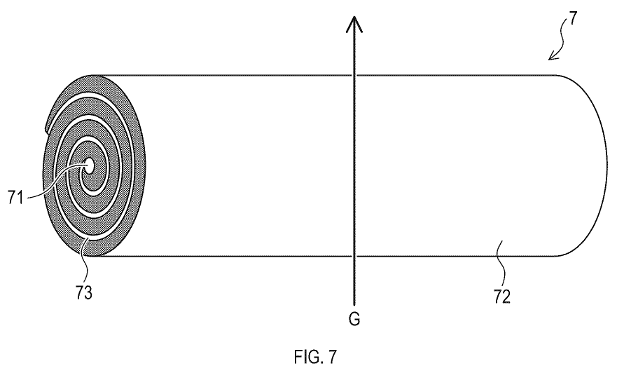

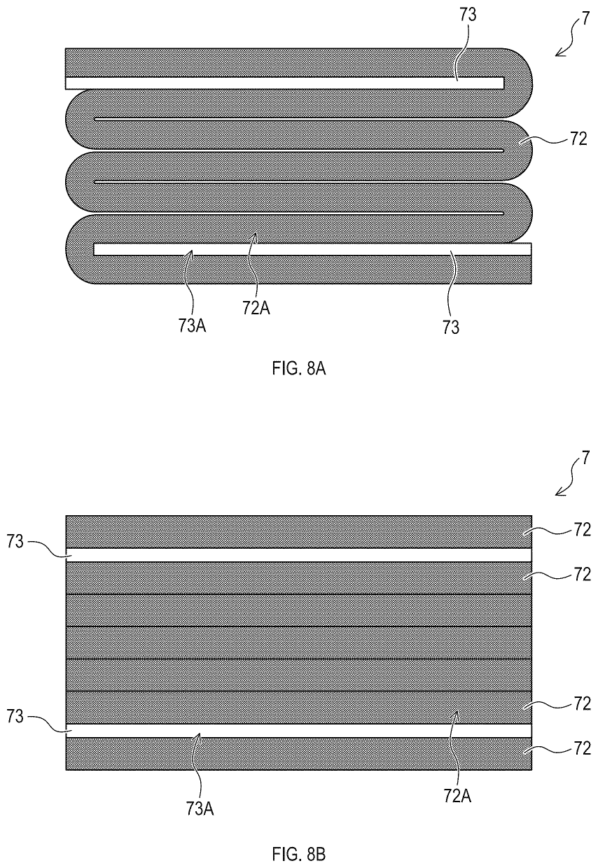

An embodiment of the present disclosure has been described hereinabove. However, it goes without saying that the present disclosure is not limited to the aforementioned embodiment and may be embodied in various forms.
(2a) In the canister of the aforementioned embodiment, in the first adsorption chamber the fuel vapor does not necessarily have to flow in the axial direction of the core material. For example, as shown in FIG. 7, the first adsorption member 7 may be arranged such that the axial direction of the core material 71 intersects with the flow direction G of the fuel vapor in the first adsorption chamber 3. In this case, the core material 71 may have a hollow shape (in other words, a hollow cylindrical shape).
(2b) In the canister of the aforementioned embodiment, the first adsorption member does not necessarily have to include the core material. The adsorption sheet and the adjustment sheet do not necessarily have to be wound around. For example, as shown in FIG. 8A, the adsorption sheet 72 may be folded to form the two or more adsorption layers 72A. In the example of FIG. 8A, the two or more adjustment sheets 73 are arranged between the folded adsorption sheet 72. As shown in FIG. 8B, the two or more adsorption layers 72A and the two or more adjustment layers 73A may be formed by stacking the two or more adsorption sheets 72 and the two or more adjustment sheets 73.
(2c) In the canister of the aforementioned embodiment, the first adsorption member does not necessarily have to include the granules. The material of the adsorption sheet (that is, the adsorption layers) only needs to be air-permeable and adsorptive, and thus is not limited to fiber.
(2d) In the canister of the aforementioned embodiment, the first adsorption member does not necessarily have to be housed in the adsorption chamber coupled to the atmosphere port. The first adsorption member may be housed in, for example, an adsorption chamber coupled to a charge port and a purge port.
(2e) One or a plurality of functions of one component in the aforementioned embodiments may be distributed as a plurality of components, or one or a plurality of functions of a plurality of components may be integrated into one component. A part of the configurations of the above embodiments may be omitted. At least a part of the configurations of the above embodiments may be added to or replaced with another configuration of the above embodiments. Any and all embodiments encompassed by the technical idea defined by the language of the claims are embodiments of the present disclosure.

What is claimed is:

1. A canister configured to adsorb and desorb fuel vapor generated in a fuel tank of a vehicle, the canister comprising:
a charge port configured to take in the fuel vapor;
a purge port configured to release the fuel vapor;
an atmosphere port open to an atmosphere;
a first adsorption chamber and a second adsorption chamber directly coupled to the charge port and the purge port, or indirectly coupled to the charge port and the purge port via an additional chamber;
a first adsorption member housed in the first adsorption chamber; and
a second adsorption member housed in the second adsorption chamber,
the first adsorption member including:
two or more adsorption layers having properties to adsorb the fuel vapor; and
an adjustment layer having an air-permeability and interposed between the two or more adsorption layers.

2. The canister according to claim 1, wherein the adjustment layer has an airflow resistance smaller than individual airflow resistances of the two or more adsorption layers.

3. The canister according to claim 1, wherein the first adsorption member includes an area in which the adjustment layer is not arranged between the two or more adsorption layers.

4. The canister according to claim 1, wherein the two or more adsorption layers and the adjustment layer are a portion of a wound body of the adsorption sheet and the adjustment sheet placed on the adsorption sheet.

5. The canister according to claim 4,
wherein the first adsorption member further includes a core material, and
wherein the adsorption sheet and the adjustment sheet are wound around the core material.

6. The canister according to claim 1, wherein the first adsorption chamber is directly coupled to the atmosphere port.

7. The canister according to claim 2, wherein the first adsorption member includes an area in which the adjustment layer is not arranged between the two or more adsorption layers.

8. The canister according to claim 2, wherein the two or more adsorption layers and the adjustment layer are a portion of a wound body of the adsorption sheet and the adjustment sheet placed on the adsorption sheet.

9. The canister according to claim 8,
wherein the first adsorption member further includes a core material, and
wherein the adsorption sheet and the adjustment sheet are wound around the core material.

10. The canister according to claim 2, wherein the first adsorption chamber is directly coupled to the atmosphere port.
